(19) United States
(12) Patent Application Publication
(10) Pub. No.: US 2008/0147485 A1
(43) Pub. Date: Jun. 19, 2008

(54) Customer Segment Estimation Apparatus

(75) Inventors: Takayuki Osagami, Yamato-shi (JP); Rikiya Takahashi, Yokohama-shi (JP)

Correspondence Address: Anne Vachon Dougherty, 3173 Cedar Road, Yorktown Hts., NY, 10598, US

(73) Assignee: International Business Machines Corporation, Armonk, NY (US)

(21) Appl. No.: 11/956,501

(22) Filed: Dec. 14, 2007

(30) Foreign Application Priority Data
Dec. 14, 2006 (JP) 2006-336621

(51) Int. Cl. G06Q 10/00

(52) U.S. Cl. 705/10

(57) ABSTRACT

In order to obtain customer state transition probabilities and short-term rewards conditioned by actions, customer behaviors are modeled with a hidden Markov model (HMM) using composite states each composed of a pair of a customer sate and a marketing action. Parameters of the estimated hidden Markov model (the composite state transition probabilities and a reward distribution for each composite state) are further transformed into the customer state transition probabilities and the distribution of rewards for each customer state conditioned by marketing actions. In order to model purchase properties in more detail, a time interval between purchases (called an inter-purchase time, below) is always included as an element in the customer state vector, thereby allowing the customer state to have information on the probability distribution of the inter-purchase time.

### FIELD OF THE INVENTION

The present invention relates to a customer segment estimation apparatus. More precisely, the present invention relates to an apparatus, a method and a program for estimating a customer segment in consideration of marketing actions.

### BACKGROUND OF THE INVENTION

In direct marketing targeted at individual customers, there has been demand for maximization of the total value of profits gained from individual customers throughout their lifetime (customer lifetime value: customer equity). To attain this, an important task in marketing is to recognize (i) how customer's behavior characteristics change over time and (ii) how to guide customer's behavior characteristics in order to increase profits of a company (i.e., to select the most suitable marketing action).

As a conventional maximization method for maximizing a customer lifetime value by using marketing actions, there have been a method using a Markov decision process (hereinafter, abbreviated as MDP) and a method using reinforcement learning (hereinafter, abbreviated as RL). The MDP method has a greater advantage in making a marketing strategy since it considers customer segments from a broader perspective.

In a case of using the MDP method, it is necessary to define customer states with Markov properties. However, the definitions of the customer states with Markov properties are not clear to humans in general. For this reason, there is a need for a tool for automatically determining definitions of customer states that satisfy Markov properties using only customer purchase data and marketing action data. The tool has a function of automatically defining M customer states satisfying Markov properties, when the number M of customer states is designated. In addition, the tool also has a function of providing transition probabilities from a customer state to other customer states with the strongest Markov properties among the ones discretely representing M customer states, and also providing a reward distribution from the customer states. The reward probability and the transition probabilities must be conditioned by marketing actions.

With a conventional technique, a hidden Markov model (hereinafter, abbreviated as HMM) is used for learning customer states with Markov properties. Examples of this have been proposed in Netzer, 0., J. M. Lattin, and V. Srinivasan (2005, July), A Hidden Markov Model of Customer Relationship Dynamics, Standford GSB Research Paper, and Ramaswamy, V. (1997), Evolutionary preference segmentation with panel survey data: An application to new products, International Journal of Research in Marketing 14, 57-80.

By use of the aforementioned conventional techniques, however, it has not been possible to define customer states in consideration of marketing actions, or to find out parameters that can be inputted to an MDP. Although Netzer, et al take into consideration short-term/long-term effects of marketing actions, its functional form is limited, so that such effects cannot be practically inputted to the MDP. On the other hand, Ramaswamy attempts to make definitions of customer states reflect effects of marketing actions from the beginning.

### SUMMARY OF THE INVENTION

In consideration of the foregoing problems, an object of the present invention is to define customer states with Markov properties with consideration of marketing actions that can be inputted to an MDP, and to obtain, as parameters of customer state, information on what kinds of effects marketing actions produce.

A first aspect of the present invention is to provide the following solving means.

The first aspect provides an apparatus for estimating a customer segment responding to a marketing action. The apparatus includes: an input unit for receiving customer purchase data obtained by accumulating purchase records of a plurality of customers, and marketing action data on actions taken on each of the customers; a feature vector generation unit for generating time series data of a feature vector composed of a pair of the customer purchase data and the marketing action data; an HMM parameter estimation unit for outputting distribution parameters of a hidden Markov model based on the time series data of the feature vector and the number of customer segments, for each composite state composed of a customer state classified by customer purchase characteristic and an action state classified by effect of a marketing action; and a state-action break-down unit for transforming the distribution parameters into parameter information for each customer segment.

More precisely, in order to estimate a customer segment (classification of customers, for example, classification of a high-profit customer segment, a medium-profit customer segment, a low-profit customer segment and the like) responding to a market action taken by a company, the apparatus receives an input of the customer purchase data, in which purchase records of the plurality of customers are accumulated, and the marketing action data of actions having been taken on each of the customers. Then, (i) the feature vector generation unit generates the time series data of the feature vector composed of a pair of the inputted customer purchase data and marketing action data. Next, (ii) the HMM parameter estimation unit outputs the distribution parameters of the hidden Markov model (HMM) based on the time series data of the feature vector outputted in (i), and the number of customer segments (additionally inputted), for each “composite state” composed of a pair of the “customer state” classified by purchase characteristic of a customer, and the “action state” classified by effect of a marketing action. At last, (iii) the state-action break-down unit transforms the distribution parameters into the parameter information (customer segment information) per customer segment. The outputted customer segment information can be used as MDP parameters.

Moreover, in an additional aspect of the present invention, the customer purchase data contain an identification number of a customer, a purchase date of the customer and a vector of a transaction made by the customer at the purchase date. In addition, the time series data of the feature vector are vector data in which information containing sales/profits produced in each purchase transaction and an inter-purchase time are associated as a pair with a marketing action related to the purchase transaction. The marketing action data contain the number of a customer targeted by a market action, a purchase date estimated as when the customer makes a purchase possibly because of an effect of the market action, and a vector of a marketing action taken at the purchase date.

Furthermore, the distribution parameters include probability distributions of sales/profits, inter-purchase times and marketing actions, which are different among composite states, and transition rates of continuous-time Markov processes each indicating a transition from a composite state to another composite state. The parameter information for each customer segment contains transition probabilities from a customer state to other customer states (hereinafter, simply called customer state transition probabilities) and short-term rewards. The state-action break-down unit receives, as an input, a time interval determined for marketing actions (for example, one month when campaigns are made every second month).

In addition to providing an apparatus having the foregoing functions, other aspects of the present invention provide a method for controlling such an apparatus, and a computer program for implementing the method on a computer.

In restating the summary of the present invention, the aforementioned problem can be solved mainly by using the following ideas. Precisely, in order to obtain the customer state transition probabilities and short-term rewards conditioned by actions, customer behaviors are modeled with a hidden Markov model (HMM) using composite states each composed of a pair of a customer sate and a marketing action. The parameters of the estimated hidden Markov model (the composite state transition probabilities and a reward distribution for each composite state) are further transformed into the customer state transition probabilities and the distribution of rewards for each customer state conditioned by marketing actions.

Furthermore, in order to model purchase characteristics in more detail, the customer state vector should always include a time interval between purchases (hereinafter, referred to as an inter-purchase time) as an element, thereby allowing the customer state to have information on the probability distribution of the inter-purchase times. Then, the problems are solved by combining the following three procedures.

(A) To generate time series data of a feature vector composed of a combination (pair) of a customer state and a marketing action taken by a company at this time;

(B) To output parameters of a hidden Markov model to which the generated time series data of the feature vector are inputted as observed results. The outputted parameters are parameters defined per composite state composed of a customer state and a marketing action, and the composite-state transition probabilities. In other words, these parameters incorporate information not only on how a customer state has changed, but also on how the company has changed its own actions.

(C) To compute the customer state transition probabilities and short-term rewards conditioned by marketing actions, by using the obtained parameters of the HMM as inputs. These can be used as MDP parameters, and thereby can be used to maximize long-term profit.

It should be noted that, unless action data of the company are inputted in (A), the composite state in (B) does not contain information on action changes of the company, which does not allow the information on the transition probabilities obtained in (C) to be different from each other among the marketing actions. In addition, if the procedure (C) is not performed, the parameters obtained at a time of completing (B) indicate unnecessary information on how company's actions changes (though future company's actions should be selected while being optimized from a company's viewpoint), so that there is no effective way of using these parameters. Accordingly, a characteristic of the present invention is to combine the three procedures (A), (B) and (C).

### BRIEF DESCRIPTION OF THE DRAWINGS

For a more complete understanding of the present invention and the advantage thereof, reference is now made to the following description taken in conjunction with the accompanying drawings.

FIG. 1 shows a functional configuration of a customer segment estimation apparatus 10 according to an embodiment of the present invention;

FIG. 2 shows a concept of time series data of vectors each composed of a pair of customer behavior and marketing action generated by a feature vector generation unit 11;

FIG. 3 shows changes over time of feature vectors as transitions between discrete composite states in an HMM parameter estimation unit 12;

FIG. 4 shows how to define a discrete customer state and an action state by factorizing each composite state into both of the axial directions in a state-action break-down unit 13;

FIG. 5 is a diagram showing that a state-action break-down unit 13 computes a rate at which a composite state composed of a combination of different customer state and action state belongs to each of known composites states;

FIG. 6 shows that the state-action break-down unit 13 computes, by using the probabilities of belonging to the composite states, a transition probability with which an arbitrary customer state transits to another customer state when an arbitrary marketing action is taken thereon;

FIG. 7 shows that the state-action break-down unit 13 computes, by using the probabilities of belonging to the composite states, rewards (profits) obtained between arbitrary customer states when an arbitrary action is taken;

FIG. 8 shows that the transition probability and reward distribution obtained by the state-action break-down unit 13 are MDP parameters;

FIG. 9 shows a generation example of feature vector time series data 23 in an example;

FIG. 10 shows a screen displaying parameters obtained by a state-action break-down unit 13 in the example;

FIG. 11 shows additional information to be displayed on the screen in FIG. 10; and

FIG. 12 is a diagram showing a hardware configuration of a customer segment estimation apparatus 10 of an embodiment of the present invention.

### DETAILED DESCRIPTION OF THE PREFERRED EMBODIMENT

According to the present invention, it is possible to examine what kinds of short-term and long-term effects marketing actions produce in accordance with customer states, and thereby to select the most suitable marketing actions in consideration of the customer states.

Hereinafter, embodiments of the present invention will be described with reference to the drawings.

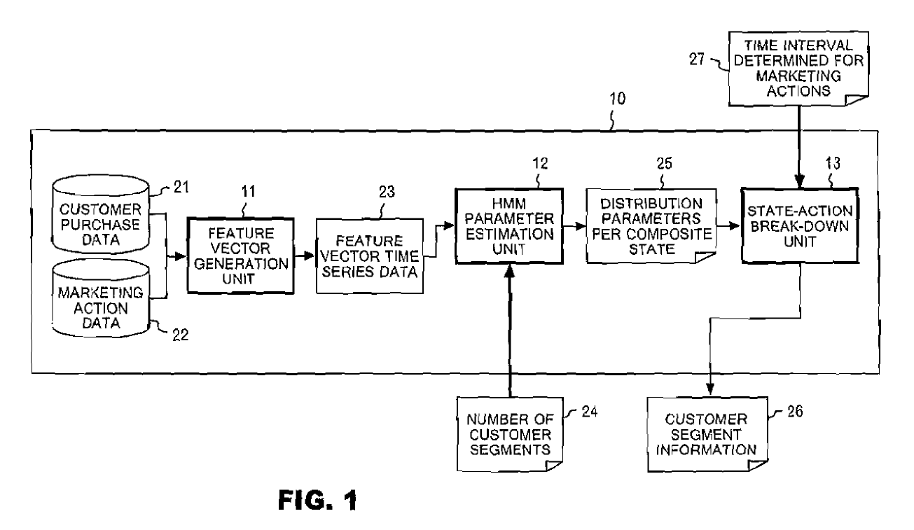

FIG. 1 is a diagram showing a functional configuration of a customer segment estimation apparatus 10 according to an embodiment of the present invention. As shown in FIG. 1, the apparatus 10 includes three computation units called a feature vector generation unit 11, an HMM parameter estimation unit 12 and a state-action break-down unit 13. In addition, units indicated by reference numerals 21 to 26 are data inputted to or outputted from the computation units, or storage units for storing the data therein.

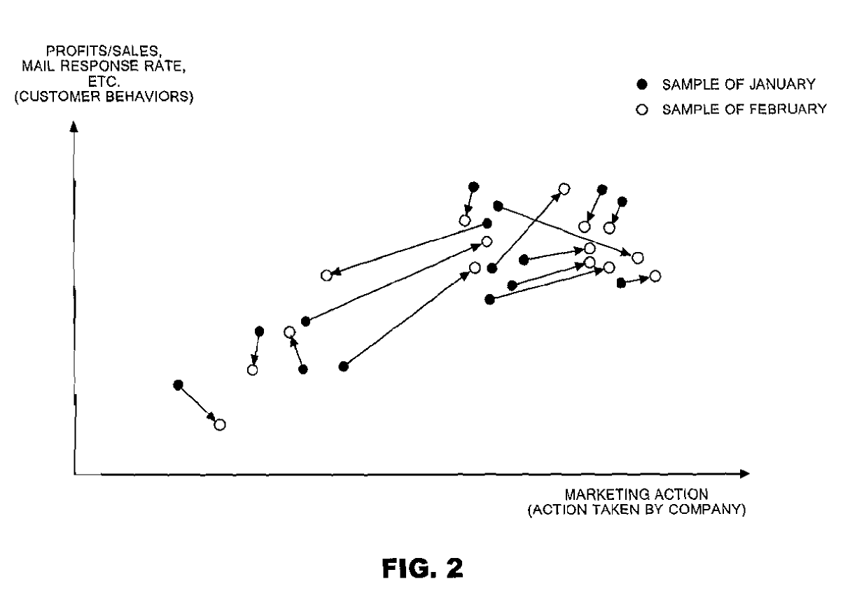

Note that, although the storage units of customer purchase data 21 and marketing action data 22 are provided in the apparatus 10 in FIG. 1, these data may be inputted from the outside through a network. Moreover, the number of customer segments 24 may be inputted by an operator directly, or by an external system. The apparatus 10 may also include input units such as a key board and a mouse, a display unit such as an LCD or a CRT, and a communication unit as a network interface. Hereinafter, general descriptions will be provided for the feature vector generation unit 11, the HMM parameter estimation unit 12, the state-action break-down unit 13 with reference to FIG. 1 together with FIGS. 2 to 8.

### <Feature Vector Generation Unit 11>

The feature vector generation unit 11 processes original data in order to apply the original data to the hidden Markov model of the present invention. The feature vector generation unit 11 generates vector data from the customer purchase data 21 and the marketing action data 22. In the vector data, information on sales/profits and the like generated per transaction and inter-purchase times are associated as a pair with marketing actions related to the transactions. In this way, feature vector time series data 23 are generated.

FIG. 2 is a conceptual diagram of time series data of vectors each composed of a set of a customer behavior and a marketing action. In FIG. 2, the vertical axis indicates customer behaviors such as profit, sales and a mail response rate, and the horizontal axis indicates marketing actions (actions carried out by a company). This example shows how samples of January (indicated by ) transit to samples of February (indicated by ◯).

### <HMM Parameter Estimation Unit 12>

The HMM parameter estimation unit 12 estimates distribution parameters 25 of a purchase model of the present invention from the feature vector time series data 23. For this estimation, the desired number of customer segments 24 is designated from the outside. Alternatively, the number of customer segments itself can also be optimized by using the designated value as an initial value. With respect to each discrete composite state called a state-action pair, the distribution parameters 25 include (i) probability distributions (of sales/profits, inter-purchase times and marketing actions) that is different from those of other composite states, and (ii) transition rates of continuous-time Markov processes indicating transitions between composite states.

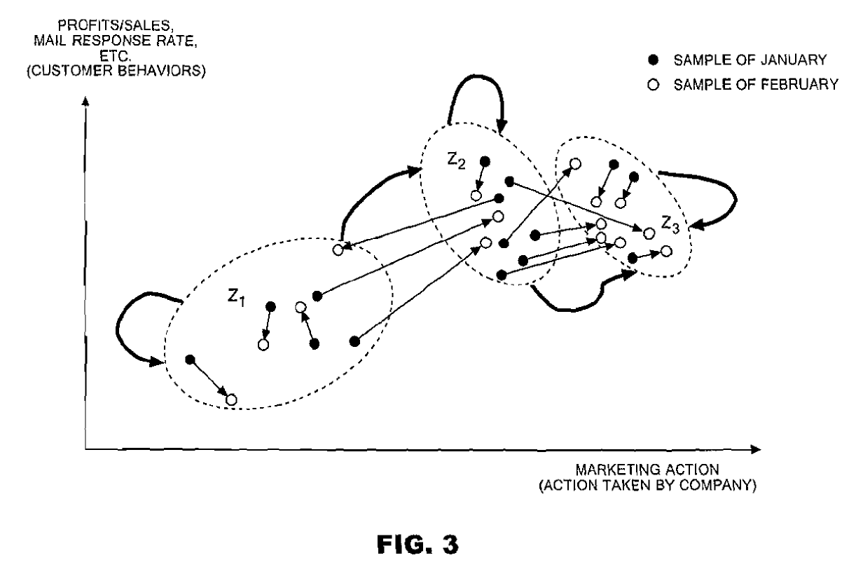

FIG. 3 shows changes over time of such feature vectors as transitions between discrete composite states. The composite states are obtained by classifying sets of customer behavior and marketing action into several categories, and are here expressed as z₁, z₂ and z₃. Detailed descriptions of the composite state will be provided later. Note that a composite state after the foregoing processing still contains meaningless information on “how company behaviors change.”

### <State-Action Break-down Unit 13>

The state-action break-down unit 13 converts the distribution parameters 25 per composite state obtained by the HMM parameter estimation unit 12, into parameters (customer segment information 26) of each customer segment that indicates original characteristics of customers. The state-action break-down unit 13 receives an input of a time interval determined for marketing actions 27 (for example, a period for a campaign if the campaign is made), and outputs (i) probability distributions (of the sales/profits and inter-purchase time) for each of the customer segments, and (ii) customer segment transition probabilities. In addition, the parameters (i) and (ii) are functions of marketing action. The parameters obtained by the state-action break-down unit 13 can be inputted to the MDP. Otherwise, the parameters may not be inputted to the MDP, but can be used for finding which customer segment tends to respond to what kind of action.

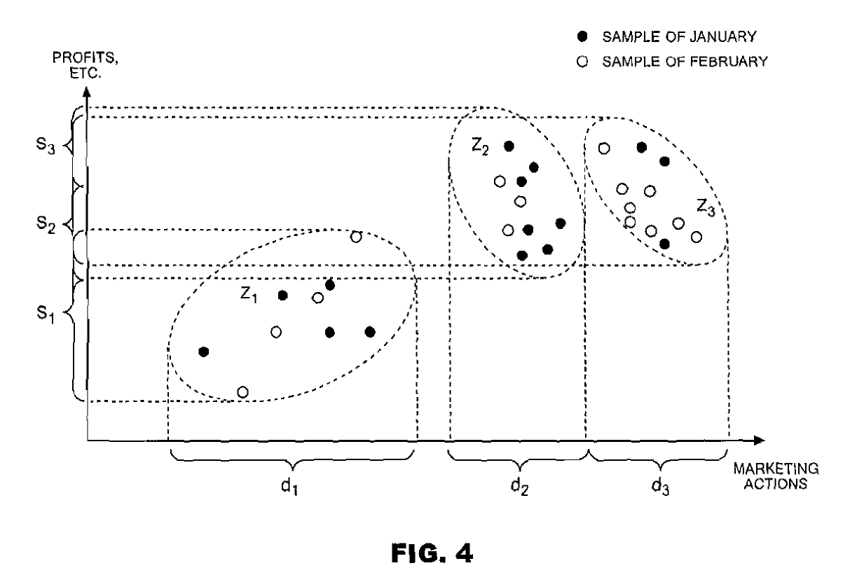

FIGS. 4 to 8 conceptually explain processing in the state-action break-down unit 13. FIG. 4 shows how to define a discrete customer state and an action state by factorizing each composite state into both of the axial directions. Here, composite states z₁, z₂ and z₃ are factorized into customer states s₁, s₂ and s₃ and action states d₁, d₂ and d₃, respectively. The customer state, the action state and the composite state will be described below.

The customer state s is one of several kinds of classes into which customer characteristics are classified. Here, the customer characteristics indicate, for example, how much money a customer is likely to spend at a shop and how often a customer is likely to visit a shop. For instance, assume that, given combinations of sales and purchase frequency as customer characteristics, the combination is classified into 4 classes. In this case, a possible classification includes the following 4 classes: s₁=(high sales and high visiting frequency), s₂=(high sales but low visiting frequency), s₃=(low sales, but high visiting frequency), and s₄=(low sales and low visiting frequency). In practice, such a classification must not be determined subjectively, but must be determined on the basis of data.

The action state d is one of several kinds of classes into which combinations of variables taken as market actions are classified according to effects of the market actions. For example, taking pricing as an example of the market actions, assume that the pricing is classified into three classes according to the effect thereof. At this time, three classes such as d₁=cheap, d₂=normal and d₃=expensive may be used for classification. The action state must not be also determined subjectively, but must be determined on the basis of data.

The composite state z is one of several classes into which combinations of a customer characteristic and marketing action taken by the company are classified. For example, given that the customer characteristic is a purchase price, and that the marketing action is a price, a possible classification example of the states (composite states) each indicating a combination of a customer characteristic and a company behavior includes z₁=(a high price is presented to a high-sales customer), z₂=(a low price is presented to a high-sales customer), z₃=(a high price is presented to a low-sales customer) and z₄=(a low price is presented to a low-sales customer). Such classification must also be determined on the basis of data, especially on the basis of a change in the customer characteristic thereafter.

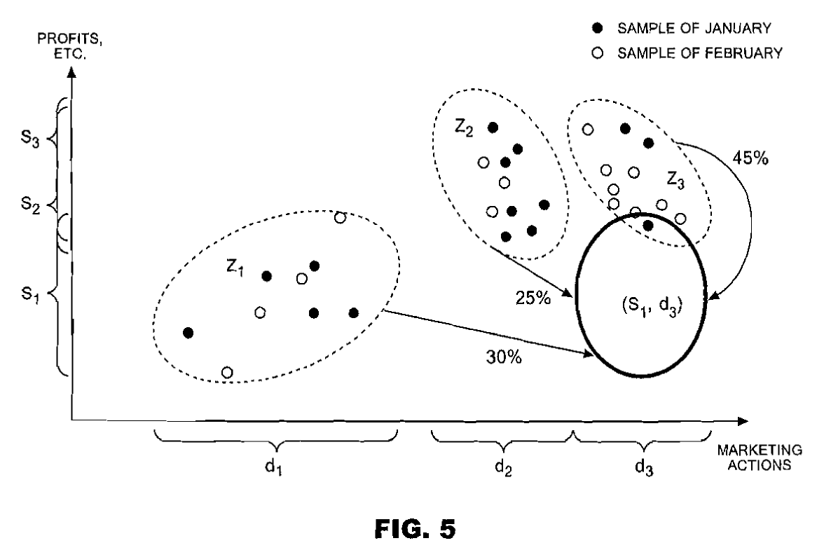

FIG. 5 is a diagram showing that it is possible to compute and thus find a rate at which an arbitrary composite state of a combination of a different customer state and action state belongs to each of the known composite states. Here, as an example, by use of statistical processing, found is a probability that a combination (s₁, d₃) of a different customer state and action state belongs to each of the composite states z₁, z₂ and z₃. The found probabilities of z₁ (s₁, d₁), z₂ (s₂, d₂) and z₃ (s₃, d₃) are 30%, 25% and 45%, respectively.

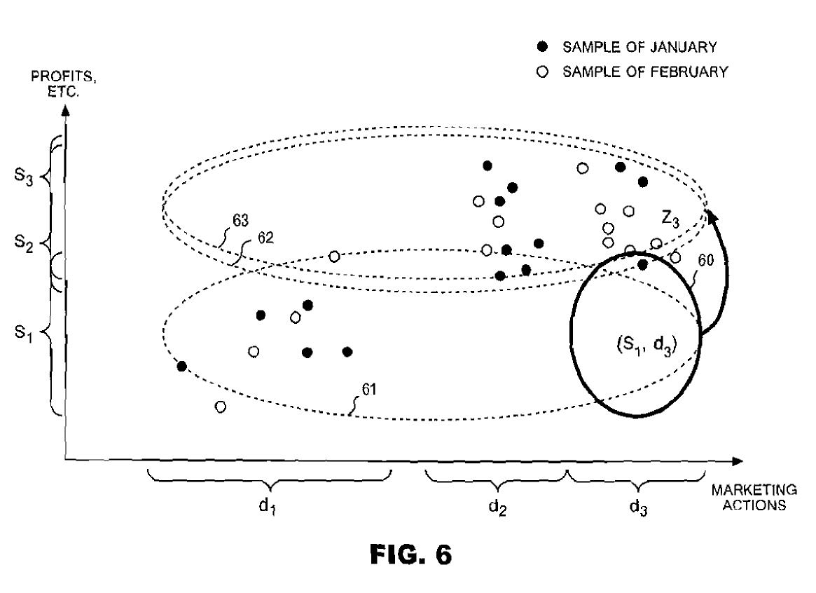

FIG. 6 shows that customer state transition probabilities are computed with the probabilities of belonging to the composite states, when an arbitrary marketing action is taken on an arbitrary customer state. In FIG. 6, assuming that the action of the action state d₃ is taken on the customer state s₁, a transition probability from the customer state s₁ to each of the customer states is computed. An oval 60 surrounding (s₁, d₃) indicates that the action of the action state d₃ is taken on the customer states s₁. Horizontally long ovals 61, 62 and 63 indicate the customer states s₁, s₂ and s₃. Each of the ovals 61, 62 and 63 is evenly distributed and extends uniformly along the horizontal axis, since the customer state does not contain the information on marketing action. Accordingly, the computation here aims to find out which point in which oval of s₁, s₂ and s₃ a point existing in the oval (s₁, d₃) is likely to transit to.

This computation uses the composite state transition probabilities, and the probabilities that the customer state s₁ belongs to composite states zₘ when the action of the action state d₃ is taken on the customer state s₁. Here, the composite state transition probabilities are already computed by the HMM parameter estimation unit 12. In addition, the probability that the customer state s₁ belongs to each of the composite states zₘ when the action of the action state d₃ is taken is computed for each of the composite states zₘ in the method shown in FIG. 5. For example, the probability that the customer state s₁ transits to the customer state s₂ when the action of the action state d₃ is taken on the customer state s₁ is computed by adding up the values obtained by multiplying the following two probabilities in regard to each of the composite states zₘ. Specifically, one of the probabilities is that the composite state z₂ is generated from each of the composite states zₘ, and the other is that the customer state s₁ belongs to each of the composite states zₘ when the action of the action state d₃ is taken on the customer state s₁.

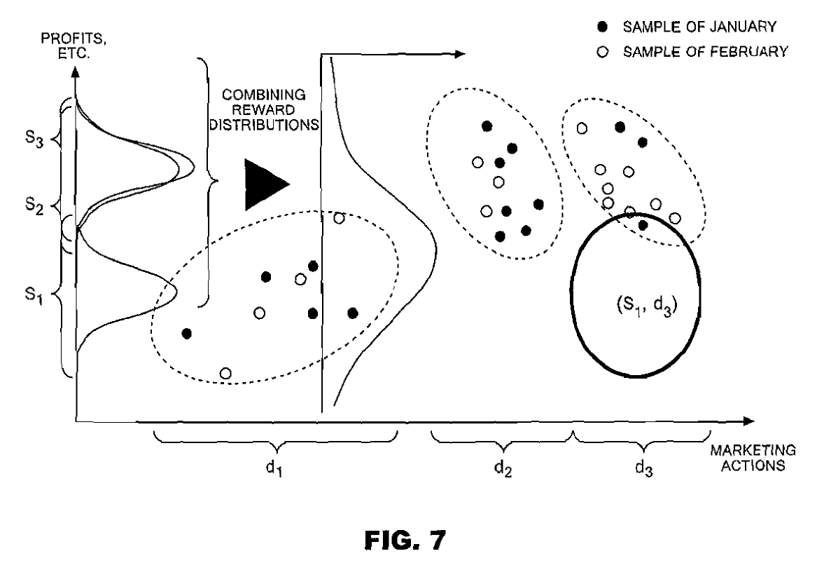

FIG. 7 shows that rewards (profits) obtained from arbitrary customer states when an arbitrary action is taken is computed by using the probabilities of belonging to the composite states. In FIG. 7, computed is the distribution of profits obtained when the action of action state d₃ is taken on the customer state s₁. The differences among the distributions of profits obtained from the customer states are known, and reflected in distribution profiles shown on the left side of FIG. 7. Accordingly, a desired distribution can be obtained if which rates to be used are known in order for all the distributions to be combined together. The combining rates are computed in the method shown in FIG. 5, as the probability that the customer state s₁ belongs to each of the composite states zₘ when the action of the action state d₃ is taken thereon. Hence, an asymmetrical distribution shown in a center part of FIG. 7 can be obtained by using these combining rates.

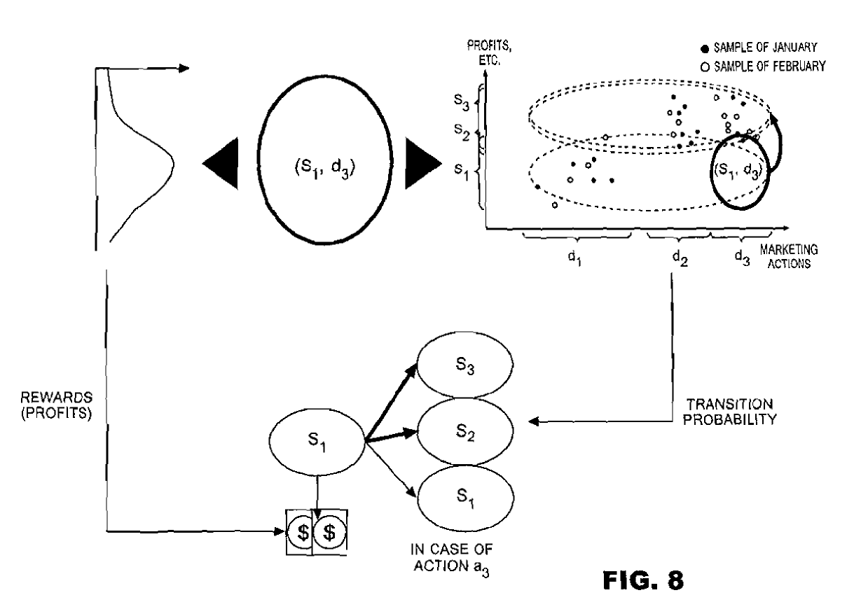

FIG. 8 shows that the obtained transition probabilities and reward distribution are MDP parameters. Here, the following probabilities and distribution are figured out when the action of the action state a₃ is taken on the customer state s₁: the probabilities that the customer state s₁ transits to s₂ and s₃; the probability that the customer state s₁ stays at s₁; and the reward (profit) distribution.

Hereinafter, detailed descriptions will be provided for a more specific computation method used in the aforementioned feature vector generation unit 11, HMM parameter estimation unit 12 and state-action break-down unit 13.

### [Feature Vector Generation Unit 11]

To the feature vector generation unit 11, customer purchase data and marketing action data are inputted. The customer purchase data include: an index c ∈ C (where C is a set of customers) indicating a customer number; t_{c, n} indicating a date when a customer c makes an n-th purchase; and a reward vector r_{c, n} of rewards produced by the customer c on the date t_{c, n}. Here, 1≦n≦N_{c} where N_{c} denotes the number of purchase transactions by the customer c. Any element can be designated as r_{c, n} as needed. Examples of such an element are a scalar quantity of a total value of sales of all products purchased on the date, and a two-dimensional vector containing total values of sales of product categories A and B arranged side by side. Not only sales but also a gross profit or an amount of used points of a promotion program may be used as the reward vector. Hereinafter, the reward vector r_{c, n} is simply referred to as a reward.

The marketing action data include:

(i) a customer number c ∈ C targeted by the marketing action,

(ii) a purchasing date t_{c, n} on which a customer makes a purchase, possibly because of the effect of the marketing action, and

(iii) a marketing action vector a_{c, n} carried out on the above date t_{c, n}.

In a case where any information among the above is not available, interpolation is performed for the information as needed. As a_{c, n}, a usable example is a discount rate of a product offered to the customer, a numerical value of bonus points provided to the customer according to a membership program, or a vector obtained by combining these two values. In addition, an action of “doing nothing” can also be defined by determining an action vector value corresponding to this action (for example, all elements are 0). Hereinafter, the marketing action vector a_{c, n} will be simply referred to as an action.

The feature vector generation unit 11 generates and outputs the following feature vector time series data 23 from the foregoing input data:

(i) a customer number c, and

(ii) a feature vector v_{c, n}=(r_{c, n}, τ_{c, n}, a_{c, n})^{T} in the n-th transaction of the customer c.

( )^{T} indicates a transposed vector. Moreover, τ_{c, n}=t_{c, n+1}−t_{c, n}, where τ_{c, n} denotes the inter-purchase time of the n-th transaction. r_{c, n} and a_{c, n} satisfy 1≦n≦N_{c}, and τ_{c, n} satisfies 1≦n≦N_{c}−1. In other words, the feature vector is a vector consisting of a combination of (the reward and the inter-purchase time, and the action). Hereinafter, {r_{c, 1}, r_{c, 2}, . . . r_{c}, N_{c}} is simply expressed as

r₁^{N}^{_{c}}. [Formula 1]

### Similarly,

a₁^{N}^{_{c}}, t₁^{N}^{_{c}}, τ₁^{N}^{_{c}}⁻¹ [Formula 2]

are defined.

### [HMM Parameter Estimation Unit 12]

### <Model and Overview>

The HMM parameter estimation unit 12 estimates parameters Q and Θ with the number M of customer segments designated from input data,

D={υ_{c,n}=(r_{c,n},τ_{c,n},a_{c,n})^{τ},r_{c,N}_{_{c}},a_{c,N}_{_{c}};c ∈ C,1≦n≦N_{c}−1}, [Formula 3]

and then outputs the parameters.

The parameter Q={qᵢⱼ; 1≦i, j≦M} is a parameter of a continuous-time Markov process called a generator matrix, and is an M×M matrix. This parameter indicates the degree of transition between latent states called composite states. The composite state is a state indicating a pair of a latent customer segment and a latent marketing action segment. The parameter Θ={Θₘ; 1≦m≦M} is a parameter showing the distribution of a feature vector assigned to each of the composite states. Θₘ denotes a distribution parameter contained in the composite state m. This parameter differs depending on what type of distribution of a feature vector is employed. The present invention does not limit the type of distribution of a feature vector, but an example of the feature vector having normal distribution will be described later.

The HMM parameter estimation unit 12 figures out the model parameters Q and Θ used to express a log likelihood of learning data as the following equations (1) and (2). There are several derivation methods for these parameters, and the present invention is not limited to any of the parameter derivation methods. When the parameters maximizing the log likelihood are figured out, a maximum likelihood estimation method is used, and, in practice, an Expectation Maximization Algorithm (EM algorithm) is used. Only an example of this case will be described later. When the expected values in the posterior distributions of parameters are figured out, a Bayesian inference method is used. In this case, practically, a variational Bayes method is used. Moreover, the HMM parameters can also be estimated by using a sampling method called a Monte Carlo Markov chain (MCMC).

$$\begin{matrix}[ Formula 4 ] & \\ L ( D \vert Q , Θ ) = {\sum }_{c ∈ C} log {\sum }_{{z}_{1}^{{N}_{c}}} P ( {r}_{1}^{{N}_{c}} , {t}_{1}^{{N}_{c}} , {a}_{1}^{{N}_{c}} , {z}_{1}^{{N}_{c}} \vert Q , Θ ) & ( 1 ) \\ P ( {r}_{1}^{{N}_{c}} , {t}_{1}^{{N}_{c}} , {a}_{1}^{{N}_{c}} , {z}_{1}^{{N}_{c}} \vert Q , Θ ) = P ( {z}_{c , 1} \vert {t}_{c , 1} ) {\prod }_{n = 1}^{{N}_{c} - 1} F ( {r}_{c , n} , {τ}_{c , n} , {a}_{c , n} \vert {Θ}_{{z}_{c , n}} ) P ( {z}_{c , n + 1} \vert {z}_{c , n} , {τ}_{c , n} , Q ) F ( {r}_{{N}_{c}} , {a}_{{N}_{c}} \vert {Θ}_{{zN}_{c}} ) & ( 2 )\end{matrix}$$

In the equations (1) and (2), z_{c, n} is the composite state generating the feature vector v_{c, n} of the n-th transaction of the customer c, and takes a value within a range of 1≦z,_{c, n} ≦M. In addition, we denote a sequence of the composite states z₁^{Nc} as

z₁^{N}^{_{c}}=z_{c,1},z_{c,2}, . . . z_{N}_{_{c}}. [Formula 5]

The equation (1) expresses the expected value of the probability of outputting a feature vector of a time series of all latent states that could occur. P(z_{c, n+1}|z_{c, n}, τ_{c, n}, Q) indicates the probability that, given the generator matrix Q, the latent state z_{c, n} of the customer c transits to the latent state z_{c, n+1} when a τ_{c, n} time elapses after the customer c makes a purchase at a time t_{c, n}. F(·|Θₘ) denotes the probability density function of outputting the feature vector designated in the latent state m.

P(z_{c, 1}|t_{c, 1}) denotes the probability of an initial state of the customer c at a time t_{c, 1}. If the number of times that the customer makes a purchase is sufficiently great, the influence of the probability of the initial state can be ignored. For simplification, assume that the initial states of all the customers c ∈ C are the same at a first purchase date t_{c, 1}.

### <Algorithm>

Here, descriptions will be given for an EM algorithm based on maximum likelihood estimation as an example of a practical method of estimating the HMM parameters. This estimation method is just an example of the application of the present invention. When the maximum likelihood estimation is used as a framework, the log likelihood is transformed into the following equation (3).

$$\begin{matrix}[ Formula 6 ] & \\ L ( D \vert Q , Θ ) = {\sum }_{c ∈ C} log {\sum }_{i} {\sum }_{j} {α}_{c , n} ( i ) F ( {r}_{c , n} , {τ}_{c , n} , {a}_{c , n} \vert {Θ}_{i} ) P ( j \vert i , {τ}_{c , n} , Q ) {β}_{c , n + 1} ( j ) & ( 3 ) \\ {α}_{c , 1} ( i ) = P ( i \vert {t}_{c , 1} ) & ( 4 ) \\ {α}_{c , n + 1} ( j ) ∝ {\sum }_{i} {α}_{c , n} ( i ) F ( {r}_{c , n} , {τ}_{c , n} , {a}_{c , n} \vert {Θ}_{i} ) P ( j \vert i , {τ}_{c , n} , Q ) & ( 5 ) \\ {β}_{c , {N}_{c}} ( i ) = 1 & ( 6 ) \\ {β}_{c , n} ( i ) = {\sum }_{j} F ( {r}_{c , n} , {τ}_{c , n} , {a}_{c , n} \vert {Θ}_{i} ) P ( j \vert i , {τ}_{c , n} , Q ) {β}_{c , n + 1} ( j ) & ( 7 )\end{matrix}$$

α_{c, n+1}(j) is referred to as the forward probability, and indicates the probability P(j|v_{c, 1}, . . . , v_{c, n}) that, given the feature vector v_{c, 1}, v_{c, 2}, . . . , v_{c, n}, the customer c is in the latent state j at the time t_{c, n+1}. This forward probability satisfies

Σⱼα_{c,n+1}=1. [Formula 7]

β_{c, n}(i) is referred to as the backward probability, and indicates the probability

P(υ_{c,n+1}, . . . , υ_{c,N}_{_{c}}|i) [Formula 9]

that a feature vector

υ_{c,n+1}, υ_{c,n+2}, . . . υ_{c,N}_{_{c}} [Formula 8]

is generated from the latent state i. α_{c, n+1}(j) β_{c, n}(i) can be recursively computed by using the formulas (5) and (7).

In order to use the EM algorithm, the infimum of the equation (3) is figured out by using the Jensen's inequality. At this time, a new latent variable

u^{ij}_{c,n} [Formula 10]

is introduced. This variable indicates the probability of an occurrence of the transition probability that the latent state i transits to the latent state j at a period [t_{c, n}, t_{c, n+1}]. When the latent variable is introduced, the estimation algorithm is expressed as follows.

### <E-step:>

$$\begin{matrix}[ Formula 11 ] & \\ {α}_{c , 1} ( i ) = P ( i \vert {t}_{c , 1} ) & ( 8 ) \\ {α}_{c , n + 1} ( j ) ∝ {\sum }_{i} {α}_{c , n} ( i ) F ( {r}_{c , n} , {τ}_{c , n} , {a}_{c , n} \vert {Θ}_{i} ) P ( j \vert i , {τ}_{c , n} , Q ) & ( 9 ) \\ {β}_{c , {N}_{c}} ( i ) = 1 & ( 10 ) \\ {β}_{c , n} ( i ) = {\sum }_{j} F ( {r}_{c , n} , {τ}_{c , n} , {a}_{c , n} \vert {Θ}_{i} ) P ( j \vert i , {τ}_{c , n} , Q ) {β}_{c , n + 1} ( j ) & ( 11 ) \\ {u}_{c , n}^{ij} ∝ {α}_{c , n} ( i ) F ( {r}_{c , n} , {τ}_{c , n} , {a}_{c , n} \vert {θ}_{i} ) P ( j \vert i , {τ}_{c , n} , Q ) {β}_{c , n + 1} ( j ) & ( 12 )\end{matrix}$$

### <M-step:>

$$\begin{matrix}[ Formula 12 ] & \\ P ( i \vert {t}_{c , 1} ) ∝ {\sum }_{c ∈ C} {α}_{c , 1} ( i ) & ( 13 ) \\ {θ}_{i} = arg {max}_{{θ}_{{l}_{i}}} {\sum }_{c ∈ C} {\sum }_{n = 1}^{{N}_{c} - 1} ( {\sum }_{j} {u}_{c , n}^{ij} ) log F ( {r}_{c , n} , {τ}_{c , n} , {a}_{c , n} \vert {θ}_{i} ) & ( 14 ) \\ Q = arg {max}_{Q} {\sum }_{c ∈ C} {\sum }_{n = 1}^{{N}_{c} - 1} {\sum }_{i} {\sum }_{j} {u}_{c , n}^{ij} log P ( j \vert i , {τ}_{c , n} , Q ) & ( 15 )\end{matrix}$$

1. Set proper initial values for the parameters Q and Θ, or for the latent variable

{u^{ij}_{c,n};c ∈ C,1≦n≦N_{c},1≦i,j≦M} [Formula 13]

2. Repeat the above E-step and M-step until the parameters converge.

In practice, the above estimation algorithm cannot be implemented unless the distribution of a feature vector and a model of the latent state transition probability are not specified. However, this distribution can be freely selected at user's own discretion. Accordingly, here, shown is only one example in which a normal distribution is used for the feature vector. When the normal distribution is used for the feature vector, in taking it in consideration that the inter-purchase time always takes a positive real number, the latent state is determined so that the inter-purchase time would follow lognormal distribution, and that the other feature vector quantities follow the normal distribution. Specifically, the latent state is modeled by using the equation

F(r_{c,n},τ_{c,n}|θₘ)=N(r_{c,n}, log τ_{c,n},a_{c,n};μₘ,Σₘ) (16), [Formula 14]

and by using Θₘ={μₘ; Σₘ} as the parameter Θₘ in practice. In addition, the latent state is expressed as the following equation,

χ_{c,n}=(r_{c,n}, log τ_{c,n},a_{c,n})^{T}. [Formula 15]

Moreover, the latent state transition probability should correspond to a continuous-time Markov process. However, in consideration of a computation time and characteristics of proper customer segments, the transition probability is approximated as shown in an equation (17). This equation is established on the assumption that the latent state does not change as rapidly as the inter-purchase time τ. Since learning of a customer segment whose customer state changes rapidly between successive purchase data is useless in practice, such an assumption is employed.

$$\begin{matrix}[ Formula 16 ] & \\ P ( j \vert i , τ , Q ) = \{ \begin{matrix}\frac{1}{1 + {λ}_{i} τ} & if j = i \\ \frac{{λ}_{i} τ}{1 + {λ}_{i} τ} {p}_{ij} & if j \neq i\end{matrix} , & ( 17 )\end{matrix}$$

where Q={qᵢⱼ; 1≦i, j≦M} is expressed using a parameter

$$\begin{matrix}[ Formula 17 ] & \\ {q}_{ij} = \{ \begin{matrix}- {λ}_{i} & if j = i \\ {λ}_{i} {p}_{ij} & if j \neq i\end{matrix} . & ( 18 )\end{matrix}$$

On the above assumption, the equation (14) of the foregoing M-step is equivalent to equations (19) and (20), and the equation (15) thereof is equivalent to equations (21) and (22).

$$\begin{matrix}[ Formula 18 ] & \\ {μ}_{i} = \frac{{\sum }_{c ∈ C} {\sum }_{n = 1}^{{N}_{c} - 1} ( {\sum }_{j} {u}_{c , n}^{ij} ) {x}_{c , n}}{{\sum }_{c ∈ C} {\sum }_{n = 1}^{{N}_{c} - 1} ( {\sum }_{j} {u}_{c , n}^{ij} )} & ( 19 ) \\ {\sum }_{i} = \frac{{\sum }_{c ∈ C} {\sum }_{n = 1}^{{N}_{c} - 1} ( {\sum }_{j} {u}_{c , n}^{ij} ) ( {χ}_{c , n} - {μ}_{i} ) {( {χ}_{c , n} - {μ}_{i} )}^{T}}{{\sum }_{c ∈ C} {\sum }_{n = 1}^{{N}_{c} - 1} ( {\sum }_{j} {u}_{c , n}^{ij} )} & ( 20 )\end{matrix}$$

It is necessary to find a solution of the equation (21) by using a one-dimensional Newton-Raphson method for each λᵢ. In practice, however, by using

$${λ}_{i} {τ}_{n} \text{<<} 1 , \frac{1}{1 + {λ}_{i} {τ}_{c , n}} ≅ 1 - {λ}_{i} {τ}_{c , n} , \qquad [ Formula 19 ]$$

the equation (21) can be computed from an equation (23).

$$\begin{matrix}\text{[Formula 20]} & \\ {λ}_{i} = \frac{{\sum }_{c ∈ C} {\sum }_{n = 1}^{{N}_{c} - 1} {\sum }_{j \neq i} {u}_{c , n}^{ij}}{{\sum }_{c ∈ C} {\sum }_{n = 1}^{{N}_{c} - 1} {τ}_{c , n} {\sum }_{j} {u}_{c , n}^{ij}} & ( 23 )\end{matrix}$$

In the case of using the equation (23), when the parameter becomes close to the local solution, the likelihood does not monotonously increase, but fluctuates up and down. For this reason, the executing of the iteration algorithm is stopped when the fluctuation starts, or the Newton-Raphson method is used after the fluctuation starts.

### [State-Action Break-down Unit 13]

The state-action break-down unit 13 transforms the parameters Q and Θ outputted by the HMM parameter estimation unit 12, receives an input of the time interval determined for marketing actions, and outputs the parameter of the discrete-time Markov Decision Process defined by M kinds of discrete customer states and M kinds of discrete action states. Both the customer states (=the reward and inter-purchase time) and the action states essentially take continuous values. However, by expressing each of the parameters as a linear combination of the parameter defined in a form of a limited number of discrete values, the solutions of the parameters can be found by using the MDP, in reality. The outputted parameters are as follows:
the parameter of the distribution of probability P(r, τ|sᵢ) that a reward r and an inter-purchase time T are generated from a customer state sᵢ.
the parameter of the distribution of probability P(a|dⱼ) that an action vector a is generated from an action state dⱼ.
the probability λₘ(i, j) that a set (sᵢ, dⱼ) of the customer state sᵢ and the action state dⱼ belongs to the composite state zₘ.
the probability P_{τ}(sₖ|sᵢ, dⱼ) that a customer in the customer state sᵢ changes the state to a customer state sₖ when a time τ elapses after an action belonging to the action state dⱼ is taken on the customer.
the parameter of the distribution of probability P(r, τ|sᵢ, dⱼ) of observing the reward r and inter-purchase time τ after an action belonging to the action state dⱼ is taken on the customer in the customer state sᵢ.

Note that τ in P_{τ}(sₖ|sᵢ, dⱼ) is manually given in consideration of an interval between campaign implementations (that is, a time interval to be used for optimization through the MDP).

A point of the state-action break-down unit 13 is to compute a rate at which a set of the i-th customer state sᵢ and the j-th action state dⱼ belongs to each of the composite states zₘ learned by the HMM parameter estimation unit 12. In short, the point is to compute λₘ(i, j) described above. According to the present invention, all of the reward, the inter-purchase time and the action vector are determined only stochastically. For this reason, even when the above set is in the i-th customer state sᵢ, the set stochastically belongs to all the composite states zₘ. Similarly, even when the set is in the j-th action state dⱼ, the set stochastically belongs to all the composite states zₘ.

Firstly, the definitions of the customer state and action state are given. The reward and inter-purchase time are generated from the customer state, and the action vector is generated from the action state. Accordingly, the customer state sᵢ and the action state dⱼ are defined as equations (24) and (25), respectively. Note that a correlation between the reward and action vector is lost by making the decomposition as shown in the equations (24) and (25).

P(r,τ|sᵢ)=∫ₐP(r,τ,a|zᵢ)da(24) [Formula 21]

P(a|dⱼ)=∫ᵣ∫_{τ}P(r,τ,a|zⱼ)drd τ (25)

Next, the state-action break-down unit 13 determines a rate at which the composite state (sᵢ, dⱼ) defined in the equations (24) and (25) belongs to each of the composite states zₘ with respect to i, j, respectively. This can be solved firstly by calculating the distance between the feature vector distribution P(v|sᵢ, dⱼ)=P(r, τ|sᵢ) P(a|dⱼ), and the feature vector distribution P(v|zₘ) of each known composite state, and then by calculating a reciprocal ratio among the distances. An arbitrary measure depending on the case can be used for this distance measure, and this example employs the Mahalanobis distance between the average value of P(v|sᵢ, dⱼ)=P(r, τ|sᵢ) P(a|dⱼ) and P(v|zₘ). Assuming that d(·, ·) denotes the distance measure between the distributions, and that λₘ(i, j) denotes the probability that, given the customer state sᵢ and the action state dⱼ, the set thereof belongs to the composite states zₘ,

p≡P(r,τ|sᵢ)P(a|dⱼ)(26) [Formula 22]

qₘ≡P(r,τ,a|zₘ) (27)

λₘ(i,j)∝1/d(p,qₘ) (28).

The parameters for the MDP are figured out from the proportional expression (28). Firstly, descriptions will be given for a procedure of figuring out the probability P_{τ}(sₖ|sᵢ, dⱼ) that the customer state sᵢ transits to the customer state sₖ when the time τ elapses after the action dⱼ is taken on the customer state sᵢ. Here, transitions to all the possible composite states to which the customer state sᵢ/action state dⱼ would belong are considered, and then the probability of obtaining the customer state sₖ from the composite states after the transitions is considered. Thus, the probability is expressed as

$$\begin{matrix}\text{[Formula 23]} & \\ {P}_{τ} ( {s}_{k} \vert {s}_{i} , {d}_{j} ) = {\sum }_{{z}_{1}} {\sum }_{{z}_{2}} P ( {s}_{k} \vert {z}_{2} ) {P}_{τ} ( {z}_{2} \vert {z}_{1} ) P ( {z}_{1} \vert {s}_{i} , {d}_{j} ) . & ( 29 )\end{matrix}$$

Paying attention to the fact that the customer state sₖ is figured out by integrating all information on the actions by using the equation (24), it practically suffices to regard P(sₖ|z₂) as 1 only when k=z₂, and as 0 otherwise (if more exact calculating is needed, Bayes' theorem may be used). As a result,

$$\begin{matrix}\text{[Formula 24]} & \\ {P}_{τ} ( {s}_{k} \vert {s}_{i} , {d}_{j} ) = {\sum }_{m} {P}_{τ} ( k \vert m ) {λ}_{m} ( i , j ) . & ( 30 )\end{matrix}$$

Subsequently, descriptions will be given for a procedure of figuring out the distribution P(r, τ|sᵢ, dⱼ) of the reward/inter-purchase time to be obtained when the action of the action state dⱼ is taken on the customer state sᵢ. To figure out this, the distribution (of reward/purchase time) at a time when a composite state and an action vector a are given is needed firstly, and this can be figured out from an equation (31).

$$\begin{matrix}\text{[Formula 25]} & \\ P ( r , τ \vert {z}_{m} , a ) = \frac{P ( r , τ , a \vert {z}_{m} )}{{\int }_{r} {\int }_{τ} P ( r , τ , a \vert {z}_{m} ) d r d τ} & ( 31 )\end{matrix}$$

There are two possible methods of figuring out P(r, τ|sᵢ, dⱼ), and use of the methods results in two cases where the mixed distribution using rates of λₘ(i, j) is obtained, and where the distribution in which parameters are mixed at rates of λₘ(i, j) is obtained. The former mixed distribution is expressed as

$$\begin{matrix}\text{[Formula 26]} & \\ P ( r , τ \vert {s}_{i} , {d}_{j} ) = {\int }_{a} {\sum }_{m} P ( r , τ \vert {z}_{m} , a ) {λ}_{m} ( i , j ) P ( a \vert {d}_{j} ) d a . & ( 32 )\end{matrix}$$

In the latter case, a specific example will be described later because a mixture of parameters is carried out in the parameter region. Since the forgoing formulas contain many integral computations, one may consider that it takes a long time to compute them. In practice, however, if a distribution that can be analytically easily tractable (for example: a multivariate normal distribution) is selected for the distribution of the feature vector, these formulas can be analytically solved. Actually necessary computation is only to compute several matrices. The aforementioned processing of the state-action break-down unit 13 can be summarized as the following steps.

Step 1: compute the distribution parameters Rᵢ and Aⱼ of P(r, τ|sᵢ) and P(a|dⱼ) by using the equations (24) and (25), and P(r, τ, a|zₘ)=f(r, τ, a|Θₘ) using Θ obtained by the HMM parameter estimation unit 12. The computations are carried out for all (i, j) of M×M ways.

Step 2: by using the parameters Rᵢ and Aⱼ found in step 1, and the formulas (26), (27) and (28), compute the probability λₘ(i, j) that, given a set of the customer state sᵢ and the action state dⱼ, the set thereof belongs to the composite state zₘ. The computations are carried out for all (i, j, m) of M×M×M ways.

Step 3: designate a desired time-interval in executing marketing actions τ to be used for the MDP. Then, from the equation (30) using Q={qij} obtained by the HMM parameter estimation unit 12 and the parameters Rᵢ and Aⱼ found in step 1, compute the probability Pτ(sₖ|sᵢ, dⱼ) that the customer state sᵢ transits to the customer state sₖ when the time τ elapses after the action belonging to the action state dⱼ is taken on the customer in the customer state sᵢ. The computations are carried out for all (i, j, k) of M×M×M ways.

Step 4: assign the parameters found in step 1 and λₘ(i, j) found in step 2 to the equations (31) and (32), thereby computing the parameter Ωᵢⱼ of the distributions P(r, τ|sᵢ, dⱼ) of probability that the reward r/inter-purchase time τ are observed when the action belonging to the action state dⱼ is taken on a customer in the customer state sᵢ. The computations are carried out for all (i, j) of M×M ways.

Step 5: P_{τ}(sₖ|sᵢ, dⱼ) obtained in step 3 and the parameters Ωᵢⱼ found in step 4 are parameters applicable to the MDP. Moreover, the parameters Rᵢ and Aⱼ found in step 1 and λₘ(i, j) figured out in step 2 are needed for assigning the actual purchase data to the customer state and the action state. Accordingly, store the parameters Rᵢ, Aⱼ, λₘ(i, j), P_{τ}(sₖ|sᵢ, dⱼ) and Ωᵢⱼ.

As an implementation example of the state-action break-down unit 13, an example of a case where (r, log₉₆ , a)^{T} is set so as to be normally distributed. In this case, various integration computations can be analytically solved in the foregoing steps. Here, in the equation

f(r,τ,a|θₘ)=N(r, log τ,a;μₘ, Σₘ) (33)

expressed separately are a component (having a subscript (s) attached thereto) relating to (r, log_{τ}) of μₘ and Σₘ, and a component (having a subscript (d) attached thereto) relating to a of μm and Σₘ, as follows. Note that a subscript (sd) is attached to a part concerning a correlation between the two components.

$$\begin{matrix}\text{[Formula 28]} & \\ {μ}_{m} = ( \begin{matrix}{μ}_{m}^{( s )} \\ {μ}_{m}^{( d )}\end{matrix} ) & ( 34 ) \\ {\sum }_{m} = ( \begin{matrix}{{\sum }_{m}}^{s} & {\sum }_{m}^{( sd )} \\ {( {\sum }_{m}^{( sd )} )}^{T} & {{\sum }_{m}}^{( d )}\end{matrix} ) & ( 35 )\end{matrix}$$

Firstly, P(r, τ|sᵢ) and P(a|dⱼ) can be respectively figured out from

$$\begin{matrix}\text{[Formula 29]} & \\ P ( r , τ \vert {s}_{i} ) = N ( r , log τ ; {μ}_{i}^{( s )} , {{\sum }_{i}}^{( s )} ) & ( 36 ) \\ P ( a \vert {d}_{j} ) = N ( a ; {μ}_{j}^{( d )} , {{\sum }_{j}}^{( d )} ) . & ( 37 )\end{matrix}$$

In order to determine λₘ(i, j), the Mahalanobis distance is computed, and

$$\begin{matrix}\text{[Formula 30]} & \\ {[ d ( p , {q}_{m} ) ]}^{2} = {( {μ}_{ij} - {μ}_{m} )}^{T} {\sum }_{m}^{- 1} ( {μ}_{ij} - {μ}_{m} ) & ( 38 )\end{matrix}$$

is obtained, where

$$\begin{matrix}\text{[Formula 31]} & \\ {μ}_{ij} = ( \begin{matrix}{μ}_{i}^{( s )} \\ {μ}_{j}^{( d )}\end{matrix} ) & ( 39 ) \\ {\sum }_{ij} = ( \begin{matrix}{\sum }_{i}^{( s )} & 0 \\ 0 & {\sum }_{j}^{( d )}\end{matrix} ) . & ( 40 )\end{matrix}$$

Hence, λₘ(i, j) is figured out from the following proportional expression (41).

$$\begin{matrix}\text{[Formula 32]} & \\ {λ}_{m} ( i , j ) ∝ {[ {( {μ}_{ij} - {μ}_{m} )}^{T} {{\sum }_{m}}^{- 1} ( {μ}_{ij} - {μ}_{m} ) + tr ( {\sum }_{m}^{- 1} {\sum }_{ij} ) ]}^{- 1} , & ( 41 )\end{matrix}$$

where Σₘλₘ(i, j)=1.

Lastly, the equation (30) is directly used, and the equations (31) and (32) are rearranged as follows,

$$\begin{matrix}\text{[Formula 33]} & \\ P ( r , τ \vert {z}_{m} , a ) = N ( r , log τ ; {μ}_{m}^{( s )} ( a ) , {\sum }_{m}^{( s )} ( a ) ) & ( 42 ) \\ {μ}_{m}^{( s )} ( a ) = {μ}_{m}^{( s )} + {\sum }_{m}^{( sd )} {( {{\sum }_{m}}^{( d )} )}^{- 1} ( a - {μ}_{m}^{( d )} ) & ( 43 ) \\ {{\sum }_{m}}^{( s )} ( a ) = {{\sum }_{m}}^{( s )} - {{\sum }_{m}}^{( sd )} {( {\sum }_{m}^{( d )} )}^{- 1} {( {\sum }_{m}^{( sd )} )}^{T} . & ( 44 )\end{matrix}$$

As described above, there are two methods of finding P(r, τ|sᵢ, dⱼ). In a case of using a mixed distribution, P (r, τ|sᵢ, dⱼ) is found as a contaminated normal distribution,

$$\begin{matrix}\text{[Formula 34]} & \\ P ( r , τ \vert {s}_{i} , {d}_{j} ) = {\sum }_{m} {λ}_{m} ( i , j ) N ( r , log τ ; {μ}_{m}^{( s )} ( i , j ) , {\sum }_{m}^{( s )} ( i , j ) ) , & ( 45 )\end{matrix}$$

where

$$\begin{matrix}\text{[Formula 35]} & \\ {μ}_{m}^{( s )} ( i , j ) = {μ}_{m}^{( s )} + {\sum }_{m}^{( sd )} {( {\sum }_{m}^{( d )} )}^{- 1} ( {μ}_{j}^{( d )} - {μ}_{m}^{( d )} ) & ( 46 ) \\ {{\sum }_{m}}^{( s )} ( i , j ) = {{\sum }_{m}}^{( s )} - {\sum }_{m}^{( sd )} {( {{\sum }_{m}}^{( d )} )}^{- 1} {( {{\sum }_{m}}^{( sd )} )}^{T} . & ( 47 )\end{matrix}$$

In a case of mixing parameters in the parameter region, P(r, τ|sᵢ, dⱼ) is found as an equation,

$$\begin{matrix}\text{[Formula 36]} & \\ P ( r , τ \vert {s}_{i} , {d}_{j} ) = N ( r , log τ ; {\sum }_{m} {λ}_{m} ( i , j ) {μ}_{m}^{( s )} ( i , j ) , {\sum }_{m} {λ}_{m} ( i , j ) {{\sum }_{m}}^{( s )} ( i , j ) ) , & ( 48 )\end{matrix}$$

that is, a single normal distribution.

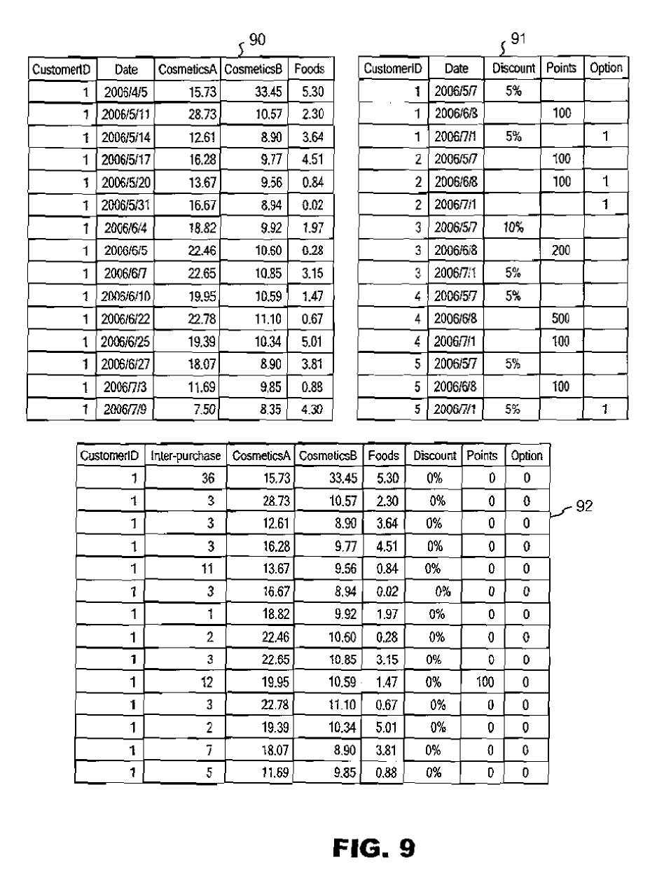

As an example of the present invention, descriptions will be given for examples of GUIs provided by software to which the present invention is applied. FIG. 9 shows an exemplar generation of feature vector time series data 23. The data on feature vector are generated from purchase records with timestamps and marketing action records that are different from the purchase records. Table 90 on the upper-left side shows the purchase records, Table 91 on the upper-right side shows the marketing action records, and Table 92 on the lower side shows the generated feature vector time series data 23. In Table 90, stored are the sales amounts (dollars) of each of product groups of products having been purchased by the customer of a Customer ID=1 in chronological order. In Table 91, marketing actions that a company has taken on the customers of Customer IDs=1 to 5 are stored similarly in chronological order. As the marketing actions, Table 91 illustrates the setting of a discount rate, the providing of points and the providing of an option. In Table 92, the timestamps are transformed into the inter-purchase times (Inter_purchase), and marketing action vectors are each allocated to a corresponding date (the next approximate date after an action is taken). Zero vectors are allocated to dates when no actions are taken. Since the purchase data are huge in practice, such data are less likely to be displayed on a screen, and the processing is automatically carried out.

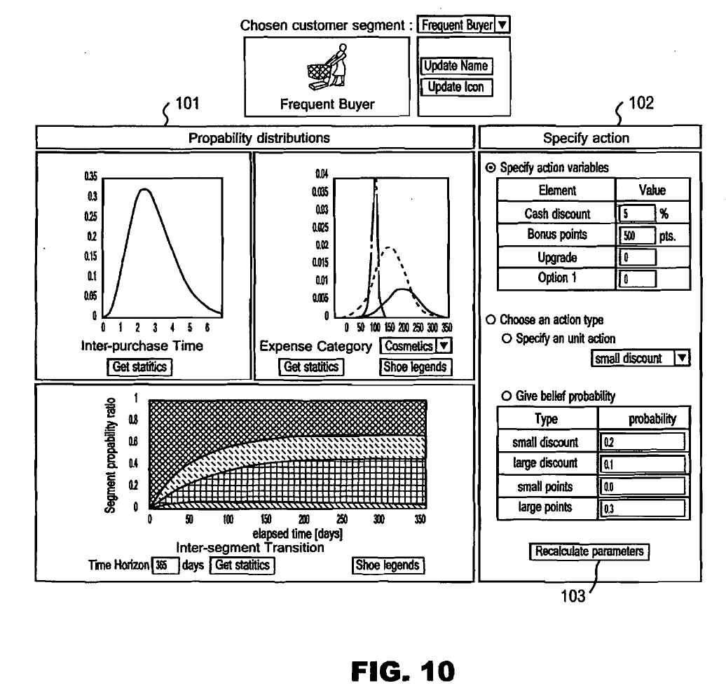

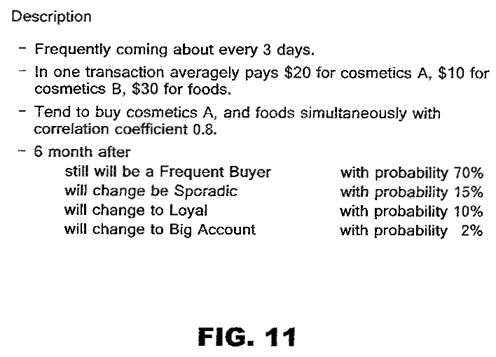

FIG. 10 is a screen displaying the parameters obtained by the state-action break-down unit 13. FIG. 10 shows characteristics of a customer state (here, referred to as a customer segment) named ‘Frequent Buyer.’ ‘Frequent Buyer’ is a name given here for convenience, and just indicates a selected one of the customer segments s₁ to s_{M}, in fact. A rectangular area 101 on the left side of the screen displays various information on the designated customer segment as information on probability distributions computed using stored parameters. The information displayed in this example is the information on the distribution of inter-purchase times, the distribution of rewards and the segment transition probabilities. FIG. 11 shows additional information displayed on the screen of FIG. 10. This information is provided as descriptions explaining tendencies of this customer state that are deduced from the distribution characteristics. The descriptions can be automatically created if appropriate rules are decided.

A rectangular area 102 written as ‘Specify action’ on the right side of the screen is a user's input area used for inputting an action vector or designating an action state. When a ‘Recalculate parameters’ button 103 is pressed after desired values and the like are inputted, the information on the left and lower sides of the screen is updated. This update reflects changes in the obtained customer state, that is, the reward, the inter-purchase time and the customer segment transition probabilities, in response to marketing actions.

The aforementioned information can help a marketer to understand a market. The marketer can especially observe changes in the customer segment transition probabilities in several different patterns by experimentally changing the values of actions in the rectangular area 102 on the right side of the screen. With this operation, the marketer can qualitatively understand what types of actions to be taken for nurturing more profitable customers. As a matter of course, in the ultimate mathematical optimization, marketing actions to be recommended are more precisely computed by solving a maximization problem of the MDP using stored parameters.

### [Hardware Configuration]

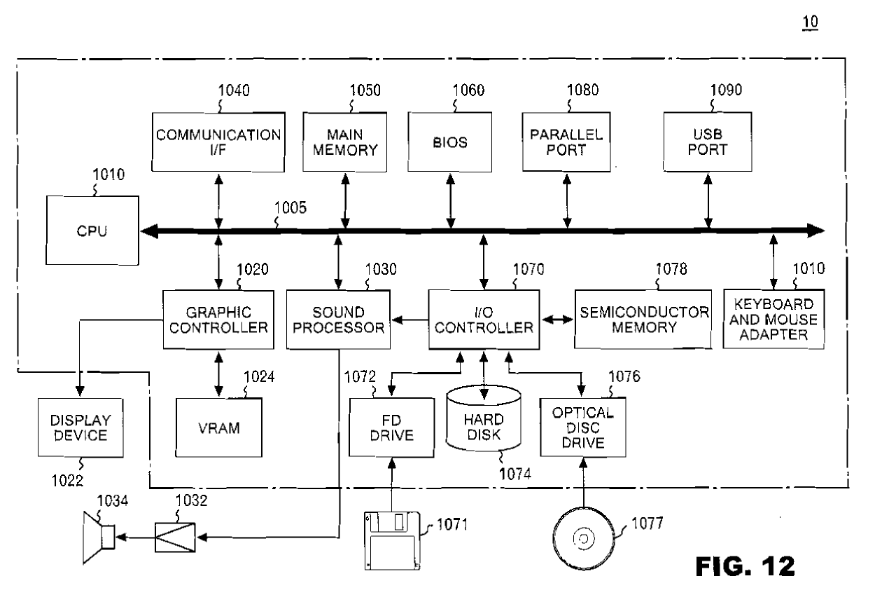

FIG. 12 is a diagram showing a hardware configuration of a customer segment estimation apparatus 10 according to an embodiment of the present invention. The general configuration will be described below as an information processing apparatus whose typical example is a computer. In a case of a dedicated apparatus or a built-in apparatus, however, a required minimum configuration can be selected in response to its installation environment, as a matter of course.

The customer segment estimation apparatus 10 includes a central processing unit (CPU) 1010, a bus line 1005, a communication I/F 1040, a main memory 1050, a basic input output system (BIOS) 1060, a parallel port 1080, a USB port 1090, a graphic controller 1020, a VRAM 1024, a sound processor 1030, an I/O controller 1070 and input means such as a keyboard and a mouse adapter 1100. A storage medium such as a flexible disk (FD) drive 1072, a hard disk 1074, an optical disc drive 1076 or a semiconductor memory 1078 can be connected to the I/O controller 1070. A display device 1022 is connected to the graphic controller 1020, and an amplifier circuit 1032 and a speaker 1034 are connected as options to the sound processor 1030.

In the BIOS 1060, stored are programs such as a boot program executed by the CPU 1010 at a startup time of the customer segment estimation apparatus 10 and a program depending on hardware of the customer segment estimation apparatus 10. The FD (flexible disk) drive 1072 reads a program or data from a flexible disk 1071, and provides the read-out program or data to the main memory 1050 or the hard disk 1074 via the I/O controller 1070.

A DVD-ROM drive, a CD-ROM drive, a DVD-RAM drive or a CD-RAM drive can be used as the optical disc drive 1076, for example. In this case, an optical disc 1077 compliant with each of the drives needs to be used. The optical disc drive 1076 can read a program or data from the optical disc 1077, and can also provide the read-out program or data to the main memory 1050 or the hard disk 1074 via the I/O controller 1070.

A computer program provided to the customer segment estimation apparatus 10 is stored in a storage medium such as the flexible disk 1071, the optical disc 1077 or a memory card, and thus is provided by a user. This computer program is read from any of the storage media via the I/O controller 1070, or downloaded via the communication I/F 1040. Then, the computer program is installed on the customer segment estimation apparatus 10, and then executed. An operation that the computer program causes the information processing apparatus to execute is the same as the operation in the foregoing apparatus, and the description thereof is omitted here.

The foregoing computer program may be stored in an external storage medium. In addition to the flexible disk 1071, the optical disc 1077 or the memory card, a magneto-optical storage medium such as an MD and a tape medium can be used as the storage medium. Alternatively, the computer program may be provided to the customer segment estimation apparatus 10 via a communication line, by using, as a storage medium, a storage device such as a hard disk or an optical disc library provided in a server system connected to a private communication line or the Internet.

The foregoing example mainly explains of the customer segment estimation apparatus 10. However, it is possible to achieve the same functions as those of the foregoing information processing apparatus by installing a program having the same functions on a computer, and then by causing the computer to operate as the information processing apparatus. Accordingly, the information processing apparatus described as an embodiment of the present invention can be constructed by using the foregoing method and a computer program of implementing the method.

The apparatus 10 of the present invention can be constructed by employing hardware, software or a combination of hardware and software. In the case of the construction using a combination of hardware and software, a typical example is the construction using a computer system including a certain program. In this case, the certain program is loaded to the computer system and then executed, thereby the certain program causing the computer system to execute processing according to the present invention. This program is composed of a group of instructions each of which an arbitrary language, code or expression can express. In accordance with such a group of instructions, the system can directly execute specific functions, or can execute the specific functions after either/both (1) converting the language, code or expression into another one, or/and (2) copying the instructions to another medium. As a matter of course, the scope of the present invention includes not only such a program itself, but also a program product including a medium in which such a program is stored. A program for implementing the functions of the present invention can be stored in an arbitrary computer readable medium such as a flexible disk, an MO, a CD-ROM, a DVD, a hard disk device, a ROM, an MRAM and a RAM. In order to store the program in a computer readable medium, the program can be downloaded from another computer system connected to the system via a communication line, or can be copied from another medium. Moreover, the program can be compressed to be stored in a single storage medium, or be divided into more than one piece to be stored in more than one storage medium.

Although the embodiments of the present invention have been described hereinabove, the present invention is not limited to the foregoing embodiments. Moreover, the effects described in the embodiments of the present invention are only enumerated examples of the most preferable effects made by the present invention, and the effects of the present invention are not limited to those described in the embodiments or examples of the present invention.

1. An apparatus for estimating a customer segment responding to a marketing action, comprising:
an input unit for receiving customer purchase data obtained by accumulating purchase records of a plurality of customers, and marketing action data on actions taken on each of the customers;
a feature vector generation unit for generating time series data of a feature vector composed of a pair of the customer purchase data and the marketing action data;
an HMM parameter estimation unit for outputting distribution parameters of a hidden Markov model based on the time series data of the feature vector and the number of customer segments, for each composite state composed of a customer state classified by customer purchase characteristic and an action state classified by the effects of a marketing action; and
a state-action break-down unit for transforming the distribution parameters into parameter information for each customer segment.

2. The apparatus according to claim 1, wherein the customer purchase data contain an identification number of a customer, a purchase date of the customer and a vector of a transaction made by the customer at that purchase date.

3. The apparatus according to claim 1, wherein the time series data of the feature vector are vector data in which information containing sales/profits produced in each purchase transaction and an inter-purchase time are associated as a pair with a marketing action related to the purchase transaction.

4. The apparatus according to claim 1, wherein the marketing action data contain the customer number targeted by a market action, a purchase date estimated as when the customer makes a purchase possibly because of an effect of the market action, and a vector of a marketing action taken at the purchase date.

5. The apparatus according to claim 1, wherein the distribution parameters include probability distributions of sales/profits, inter-purchase times and marketing actions, which differ among composite states, and transition rates of continuous-time Markov processes indicating transitions from a composite state to other composite states.

6. The apparatus according to claim 1, wherein the parameter information for each customer segment contains transition probabilities from a customer state to other customer states, and a short-term reward.

7. The apparatus according to claim 1, wherein the state-action break-down unit receives a time interval determined for marketing actions as an input.

8. A method of estimating a customer segment responding to a marketing action; comprising the steps of:
receiving customer purchase data obtained by accumulating purchase records of a plurality of customers, and marketing action data on actions taken on each of the customers;
generating time series data of a feature vector composed of a pair of the customer purchase data and the marketing action data;
outputting distribution parameters of a hidden Markov model based on the time series data of the feature vector and the number of customer segments, for each composite state composed of a customer state classified by customer purchase characteristic and an action state classified by effect of a marketing action; and
transforming the distribution parameters into parameter information for each customer segment.

9. A computer program for estimating a customer segment responding to a marketing action, causing a computer to execute the steps of:
receiving customer purchase data obtained by accumulating purchase records of a plurality of customers, and marketing action data on actions taken on each of the customers;
generating time series data of a feature vector composed of a pair of the customer purchase data and the marketing action data;
outputting distribution parameters of a hidden Markov model based on the time series data of the feature vector and the number of customer segments, for each composite state composed of a customer state classified by customer purchase characteristic and an action state classified by effect of a marketing action; and
transforming the distribution parameters into parameter information for each customer segment.
